(19) United States
(12) Patent Application Publication
(10) Pub. No.: US 2017/0312661 A1
(43) Pub. Date: Nov. 2, 2017

(54) SELF-CLEANING THREE WAY VALVE FOR USE WITH A WATER PURIFIER

(71) Applicant: Xiamen Runner Industrial Corporation, Xiamen (CN)

(72) Inventors: BO-HUANG LIU, Xiamen (CN); DE-LIANG WANG, Xiamen (CN)

(21) Appl. No.: 15/582,003

(22) Filed: Apr. 28, 2017

(30) Foreign Application Priority Data
Apr. 29, 2016 (CN) 201620375521.X

(51) Int. Cl. B01D 29/66; F16K 31/06; C02F 1/00

(52) U.S. Cl. CPC B01D 29/668; C02F 1/001; F16K 31/0603

(57) ABSTRACT

A three way valve adapted to be connected to a water purifier includes a body, an inlet defined in the body for communication with a water source, a first outlet defined in the body to constantly communicate with the inlet, a waterway defined inside the body and between the inlet and the first outlet to communicate the inlet and the first outlet and a second outlet selectively communicating with the waterway. A solenoid valve is mounted to control the communication between the second outlet and the waterway so that pollutant screened by a filtering screen is flushed out from the outlet whenever water is flowing from the inlet to the outlet.

### BACKGROUND OF THE INVENTION

### Field of the Invention

The present invention relates a to a self-cleaning three-way valve and, more particularly, to a self-cleaning three-way valve adapted to be used with a water purifier.

### Description of the Related Art

There are numerous types of water purifiers in our daily lives to clean pollutant in the water from the water plant and thus provide drinkable water. Currently, the cleaning process for the commercially available water purifiers mainly depends on a filtering screen installed between the inlet and the outlet of the water purifier. With the filtering screen installed, the pollutant is filtered out from the water source, i.e., the water plant. However, with the advance of time, the pollutant is accumulated on the filtering screen and the user will have to remove the filtering screen from the water purifier for removing the pollutant from the filtering screen or the objective of providing cleaned water by the water purifier is not satisfactory. To obviate the difficulties caused from the structural limitations of the water purifier while removing the filtering screen for cleaning, there is provided with an easy access window in the water purifier so that the user is able to use the window to monitor the pollutant and access the filtering screen for cleaning process. Nevertheless, this “window type” water purifier still requires the user to clean the filtering screen from time to time in order to meet the cleaning expectation from the users, which is very annoying and troublesome as it requires devotion and time from the user.

In order to describe the detailed structure as well as the function of the elements of the three-way valve of the embodiment of the present invention, a series of drawings are attached.

### SUMMARY OF THE INVENTION

In view of the problems and drawbacks of the prior art, the objective of the embodiment(s) of the present invention is to provide a three-way valve featuring a self-cleaning function to completely eliminate the need for periodical removal and cleaning of the filter screen.

To achieve the foregoing objective, the three way valve constructed in accordance with the embodiment(s) of the present invention has an inlet for communication with a water source, a waterway communicating with the inlet, a first outlet communicating with the inlet via the waterway and a second outlet selectively communicating with the waterway via a filtering screen and a solenoid valve to allow the filtering screen to be constantly influenced by waterflow inside the waterway so that pollutant screened by the filtering screen will be flushed out from the outlet and cleaning of the filtering screen is no longer required.

Another objective of the embodiment of the present invention is that a passage is formed to constantly communicate with the second outlet and selectively communicate with the waterway via the filtering screen and the solenoid valve such that water inside the waterway is able to flow to the second outlet after being screened by the filtering screen.

### BRIEF DESCRIPTION OF THE DRAWINGS

The detailed description of the drawings particularly refers to the accompanying figures in which:

FIG. 1 is a schematic plan view of the three-way valve of the present invention;

FIG. 2 is another plan view of the three-way valve of the present invention;

FIG. 3 is a cross sectional view of the three-way valve of the embodiment of the present invention along line A-A in FIG. 1, wherein the solenoid valve is activated;

FIG. 4 is still a cross sectional view of the three-way valve of the embodiment of the present invention indicating waterflow when the solenoid valve is inactive; and

FIG. 5 is a plan view showing the application of the three-way valve with a water purifier and a faucet.

### DETAILED DESCRIPTION OF THE INVENTION

The purpose, construction, features, functions and advantages of the present invention can be appreciated and understood more thoroughly through the following detailed description with reference to the attached drawings.

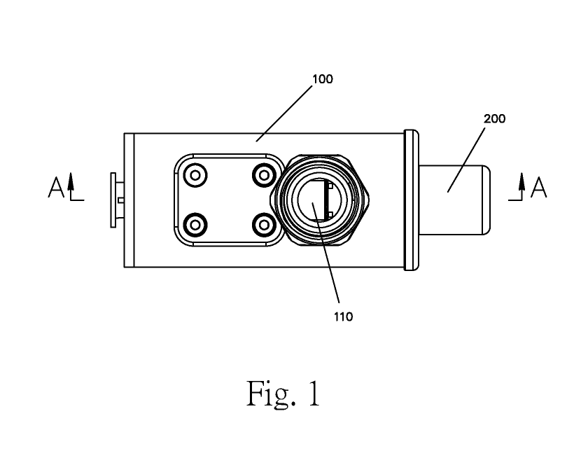

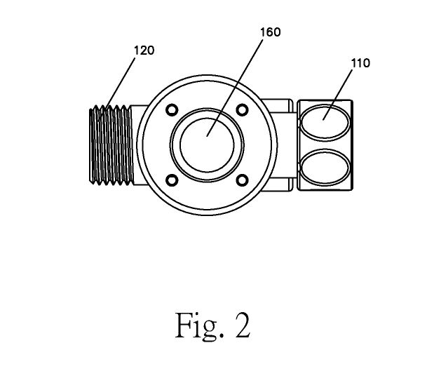

With reference to FIGS. 1, 2 and 3, a three way valve constructed in accordance with the embodiment of the present invention has a body 100, a waterway 130 defined inside the body 100, an inlet 110 defined in one end of the body 100 and communicating with the waterway 130, a first outlet 120 communicating with both the inlet 110 and the waterway 130, a side hole 150 defined in a side face defining the waterway 130 and communicating with both the inlet 110 and the first outlet 120, a filtering screen 151 mounted around a flange forming the side hole 150, a passage 140 defined inside the body 100 and extended through the side hole 150 and a second outlet 160 defined in the body 100 to communicate with the passage 140. It is noted that the extension direction of the passage 140 is crossed with the waterway 130 in a perfect right angle.

It is noted that one side of the side hole 150 is mounted with the filtering screen 151 and the other side of the side hole 150 is provided with a solenoid valve 200 to control the communication between the passage 140 and the side hole 150, which allows water flowing inside the waterway 130 to selectively flow to the second outlet 160 when the communication between the side hole 150 and the passage 140 is activated by the solenoid valve 200.

Furthermore, a buffering room 170 is formed inside the body 100 and between the passage 140 and the second outlet 160 to slow down velocity of the waterflow from the passage 140 to the second outlet 160. A flowmeter 180 is mounted inside the buffering room 170 to measure quantity of waterflow passing the buffering room 170 so that when the quantity of waterflow reaches a previously determined level, a signal may be sent to signal the user.

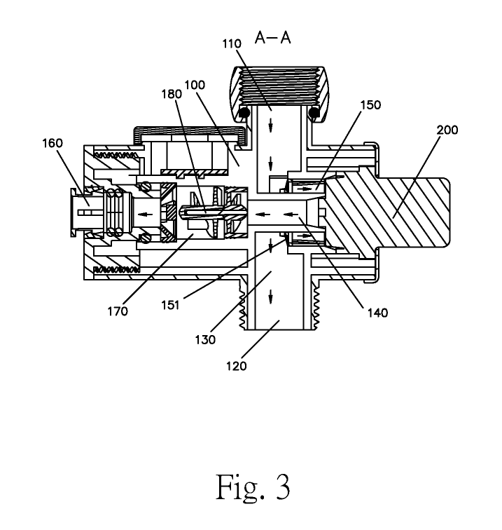

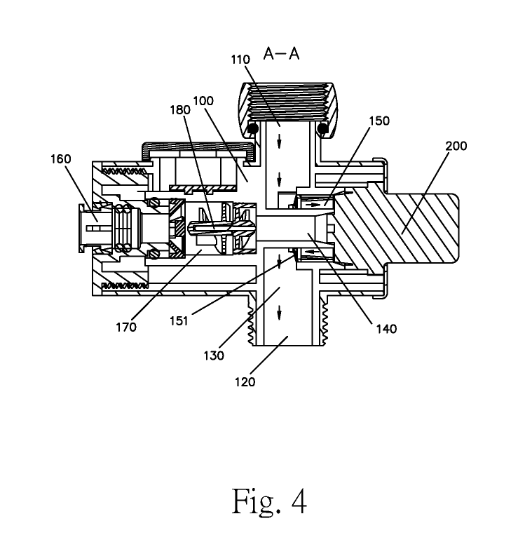

With reference especially to FIGS. 3 and 4, it is leaned that the inlet 110 is in communication with the first outlet 120 via the waterway 130. Therefore, when the solenoid valve 20 is in inactive or not in operation, there is no communication between the passage 140 and the waterway 130 and waterflow inside the waterway 130 from the inlet 110 is able to flow directly to the first outlet 120, as shown in FIG. 4. When the solenoid valve 200 is operated to open the communication between the side hole 150 and the passage 140, waterflow inside the waterway 130 flows through the filtering screen 151, the side hole 150, the passage 140, the buffering room 170 and eventually to the second outlet 160 while pollutant, if any, is left behind the filtering screen 151 and exposed inside the waterway 130. Next time, when the first outlet 120 is switched open by, for example, a faucet, the pollutant will be flushed out from the first outlet 120, which completes the self-cleaning process of this three-way valve of the embodiment of the present invention.

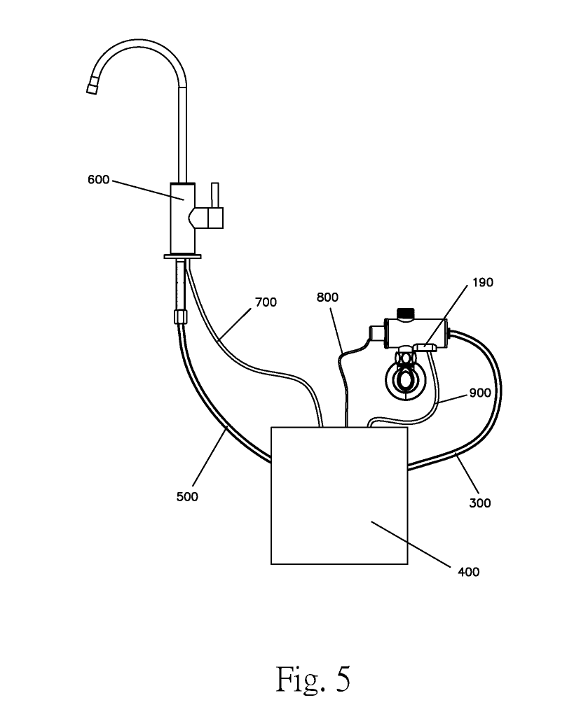

Furthermore, it is to be noted that the second outlet 160 of the body 100 of the self-cleaning three-way valve of the embodiment of the present invention is adapted to be connected to a water purifier 400 via a first connecting pipe 300, as shown in FIG. 5. The water purifier 400 is connected to a faucet 600 via a second connecting pipe 500. A first dataline 700 is provided between the faucet 600 and the water purifier 400 and a second dataline 800 is provided between the water purifier 400 and the solenoid valve 200. Still, a third dataline 900 is provided between the water purifier 400 and a circuit board 190 of the body 100. When a ceramic core of the faucet 600 is turned on and detected, a signal is sent to the water purifier 400 via the first dataline 700 and the water purifier 400 sends the signal to the solenoid valve 200 via the second dataline 800 to turn on the solenoid valve 200, which turns on the communication between the side hole 150 and the passage 140 to allow water from the inlet 110 to eventually flow to the second outlet 160. When the ceramic core of the faucet 600 to turned off, a shut-off signal is sent to the water purifier 400 via the first dataline 700 and the water purifier 400 sends the signal to the solenoid valve 200 via the second dataline 800 to turn off the solenoid valve 200, which turns off the communication between the side hole 150 and the passage 140 to stop water from the inlet 110 to flow to the second outlet 160. In order to closely monitor the status of the water purifier 400, a flowmeter 180 is installed inside the body to measure the quantity flowing through the buffering room 170, the second outlet 160 and eventually into the water purifier 400.

What is claimed is:

1. A three way valve adapted to be connected to a water purifier, the three valve comprising:
a body;
an inlet defined in the body for communication with a water source;
a first outlet defined in the body to constantly communicate with the inlet;
a waterway defined inside the body and between the inlet and the first outlet to communicate the inlet and the first outlet and having a side hole defined in a side face defining the waterway and provided with a filtering screen mounted thereon;
a second outlet selectively communicating with the side hole via the filtering screen; and
a solenoid valve mounted on the side hole to control the communication between the second outlet and the side hole so that pollutant screened by the filtering screen is flushed out from the outlet whenever water is flowing from the inlet to the outlet.

2. The three way valve as claimed in claim 1, wherein the body further has a passage defined between the second outlet and the side hole.

3. The three way valve as claimed in claim 1, wherein the body further has a buffering room defined between the passage and the second outlet to slow down waterflow inside the body.

4. The three way valve as claimed in claim 2, wherein the body further has a buffering room defined between the passage and the second outlet to slow down waterflow inside the body.

5. The three way valve as claimed in claim 4, wherein the body has a flowmeter installed to monitor water quantity flowing through the buffering room.

6. The three way valve as claimed in claim 4, wherein an extension direction of the passage is crossed with that of the waterway in a right angle manner.
